(19) United States
(12) Patent Application Publication
(10) Pub. No.: US 2022/0115694 A1
(43) Pub. Date: Apr. 14, 2022

(54) LITHIUM ION BATTERIES WITH HIGH VOLTAGE ELECTROLYTE ADDITIVES

(71) Applicant: WILDCAT DISCOVERY TECHNOLOGIES, INC, San Diego, CA (US)

(72) Inventors: Ye Zhu, San Diego, CA (US); Jinhua Huang, San Diego, CA (US); Gang Cheng, San Diego, CA (US); Deidre Strand, San Diego, CA (US)

(21) Appl. No.: 17/067,994

(22) Filed: Oct. 12, 2020

(51) Int. Cl. H01M 10/0567; H01M 10/0525; H01M 10/0569; H01M 4/131; H01M 4/134; H01M 4/525

(52) U.S. Cl. CPC H01M 10/0567; H01M 10/0525; H01M 4/525; H01M 4/131; H01M 4/134; H01M 10/0569

(57) ABSTRACT

A lithium ion battery includes a cathode, an anode, and an electrolyte. The electrolyte includes a lithium salt, a solvent, a first additive, and a second additive. The first additive contributes to formation of a cathode solid electrolyte interface (SEI) on a surface of the cathode. The second additive contributes to formation of an anode SEI on a surface of the anode. The first additive is one or more of a phosphonite compound, a phosphoranylidene compound, or a fluorocyclophosphazene compound

### BACKGROUND

The present invention is in the field of battery technology.

One goal in developing new lithium ion secondary batteries is to increase the energy density of the batteries in order to store more energy per unit volume. An increased density can enable producing smaller batteries without sacrificing charge capacity as well as producing the same size of batteries with a greater charge capacity than conventional batteries. Charging lithium ion batteries at higher voltages, such as above 4.3 V, can increase the energy density. However, conventional battery components are unstable at high voltages. The electrolyte within the battery may decompose and/or degrade when charged to high voltages, such as above 4.3 V, which significantly diminishes the battery cycle life. For example, at high voltages, catalytic oxidation of the electrolyte may occur in the presence of the cathode material, which can produce undesirable products that affect both the performance and safety of the battery. In addition, the anode material may cause undesirable reductions within the electrolyte. Further, the decomposition of the electrolyte at higher voltages can generate gas (such as carbon dioxide, oxygen, ethylene, and hydrogen) and acidic products, either of which can damage a battery. Even when installing state-of-the-art high-energy cathode active materials in the battery, only a fraction (e.g., 50%) of the theoretical capacity of some known high-energy cathode materials can be used to maintain a stable cycle life. Thus, known lithium ion batteries cannot be reliably charged and discharged at high voltages to increase the energy density due to the associated stability issue.

### BRIEF SUMMARY

In one or more embodiments, a lithium ion battery is provided that includes a cathode, an anode, and an electrolyte. The electrolyte includes a lithium salt, a solvent, a first additive, and a second additive. The first additive contributes to formation of a cathode solid electrolyte interface (SEI) on a surface of the cathode. The second additive contributes to formation of an anode SEI on a surface of the anode. The first additive is one or more of a phosphonite compound, a phosphoranylidene compound, or a fluorocyclophosphazene compound.

In one or more embodiments, a lithium ion battery is provided that includes a cathode, an anode, and an electrolyte. The electrolyte includes a lithium salt, a solvent, and a phosphoranylidene additive that contributes to formation of a cathode solid electrolyte interface (SEI) on a surface of the cathode. The phosphoranylidene additive is represented by formula (i) or formula (ii):

R₁R₂R₃P═NR₄ (i)

R₁R₂R₃P═C═C═X (ii)

In formulas (i) and (ii), R₁, R₂, and R₃ are each independently an alkyl group, an aromatic group, a heteroaromatic group, a vinyl group, or an alkenyl group. In formulas (i) and (ii), R₄ is an alkyl group, an aromatic group, a heteroaromatic group, a vinyl group, an alkenyl group, a carbonyl group, —N⁺═C⁻, Ph₃P⁺, —P═OPh₂, —Si(R¹R²R³), or —SO₂—R₁. In formula (ii), X is one of O, S, NR₁, CHR₁, CHOR₁, CR₁R₂, CHF, CHCl, or CHBr.

### BRIEF DESCRIPTION OF THE DRAWINGS

FIG. 1 illustrates a lithium ion battery according to one or more embodiments.

FIG. 2 is a table that summarizes data for cycle life testing of lithium ion battery cells according to some embodiments.

FIG. 3 is a graph showing capacity retention of a phosphoranylidene additive over 200 cycles when paired with different anode SEI formation additives according to an embodiment.

FIG. 4 is a graph showing capacity retention of a fluorocyclophosphazene additive over 200 cycles when paired with different anode SEI formation additives according to an embodiment.

FIG. 5 is a graph showing capacity retention of a phosphonite additive over 200 cycles when paired with different anode SEI formation additives according to an embodiment.

### DETAILED DESCRIPTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The term “halogen atom” refers to any of the five chemical elements fluorine (F), chlorine (Cl), bromine (Br), iodine (I), and astatine (At).

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at 30 degrees C., unless the context clearly dictates otherwise.

Ranges presented herein are inclusive of their endpoints. Thus, for example, the range 1 to 3 includes the values 1 and 3 as well as the intermediate values.

Embodiments of the inventive subject matter provide lithium ion secondary batteries that have electrolytes specifically formulated to increase the stability of the batteries when charged and discharged at high voltages. As used herein, high voltages refer to voltages greater than 4.3 V relative to a lithium (Li/Li⁺) counter electrode. The lithium ion secondary batteries described herein may also have increased stability when charged and discharged at super high voltages, which refer to voltages greater than 4.4 V relative to a reference counter electrode. The electrolytes according to the embodiments may increase stability by the inclusion of specific additives. Although the additives are specifically selected and the electrolytes specifically formulated for enhanced stability at high voltages to achieve high energy density batteries, it is recognized that the battery formulations described herein can also be operated at lower voltages and provide similar or better performance and cycle life at the lower voltages compared to the higher voltages.

The specific additives in the electrolyte may provide stability at high voltages by contributing to the formation of an electrochemically and mechanically robust cathode solid electrolyte interface (SEI) layer on the cathode surface. The cathode SEI layer may passivate the cathode material and blocks undesired side reactions between the cathode and the electrolyte, such as the generation of gas and/or acidic products, which can degrade battery performance and/or life. The electrolyte additives disclosed herein that contribute to the cathode SEI formation contain phosphorus. The phosphorus-containing additives can be oxidized prior to the bulk electrolyte components to form the cathode SEI layer which restricts oxidation of the electrolyte by the cathode active material. The phosphorus-containing additives can contribute to the formation of the cathode SEI without contributing to the formation of an anode SEI layer on the anode surface. Such preferential or selective film formation on the cathode can impart stability against oxidative decomposition, with little or no additional film formation on the anode (beyond the anode SEI) that can otherwise degrade battery performance through resistive losses. More generally, the phosphorus-containing additives may decompose below a redox potential of the cathode material and above a redox potential of SEI formation on the anode. The SEI layers are described in more detail in U.S. application Ser. No. 15/991,899, entitled High Voltage Electrolyte Additives, which is incorporated by reference herein in its entirety.

The phosphorus-containing additives according to the embodiments disclosed herein are selected from the following classes: phosphonite compounds, fluorocyclophosphazene compounds, and phosphoranylidene compounds. The electrolytes with the phosphorus-containing additives are specifically formulated to improve capacity retention over the cycle life of the lithium ion batteries at high voltages and super high voltages.

In one or more embodiments, the electrolyte formulation includes a first phosphorus-containing additive that contributes to the formation of the robust cathode SEI layer on the cathode and a second additive that reduces gas generation and/or contributes to the formation of an electrochemically and mechanically robust anode SEI layer on the anode surface. The first additive is also referred to herein as a high voltage additive and as a cathode SEI formation additive. The second additive may not contribute to the formation of the robust cathode SEI layer on the cathode. The second additive is also referred to herein as an anode SEI formation additive. Although additional components in the electrolyte, such as a lithium salt and a solvent, may be involved in the formation of the cathode and anode SEI layers, the first and second additives may be specifically selected due to the synergistic effect of improving the properties of both corresponding protective layers. For example, the additives can improve the properties of the SEI layers by contributing to the formation of robust layers that restrict oxidation of the electrolyte without unduly increasing the electrical resistance of the electrodes. The anode SEI formation additive, which contributes to the formation of the anode SEI without contributing to the formation of the cathode SEI, can include one or more of fluoroethylene carbonate (referred to herein as FEC), lithium bis(trifluoromethanesulfonyl)imide (referred to herein as LiFSI), lithium difluoro(oxalato)borate (referred to herein as LiDFOB), and the like. In addition to or instead of the second additive, the electrolyte formulation may include at least one gas reduction additive (which may represent a second additive or a third additive). The at least one gas reduction additive can include 1,3-propane sultone (referred to herein as PS), succinonitrile (referred to herein as SN), and 1,3,6-hexanetricarbonitrile (referred to herein as HTCN). For example, the gas reduction additives and anode SEI formation additives may include only one of the above-listed compounds or multiple of the compounds in combination, such as LiFSI with PS.

The lithium ion batteries disclosed herein have cathode active materials associated with relatively high energy density. In a non-limiting example, the cathode active material is lithium cobalt oxide (referred to herein as LCO). The phosphorus-containing additive present in the electrolyte is selected based on the ability of the additive to form a desirable cathode SEI layer on the specific high energy density cathode active material, such as LCO, present in the battery cell. In at least one embodiment, the anode active material is a graphite composite, although other anode active materials can be used in other embodiments.

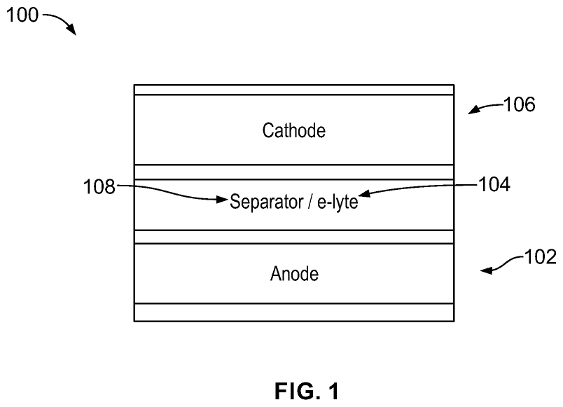

FIG. 1 illustrates a lithium ion battery 100 according to one or more embodiments. The battery 100 includes an anode 102, a cathode 106, and a polymer separator 108 that is disposed between the anode 102 and the cathode 106. The battery 100 also includes an electrolyte 104, which is disposed within and between the anode 102 and the cathode 106. The composition of the electrolyte 104 is formulated to remain stable during high voltage battery cycling. The electrolyte 104 can have a liquid, gel, or solid phase during operation of the battery 100. In at least one embodiment, the electrolyte 104 is liquid.

The lithium ion battery 100 can be secondary battery, which indicates that the battery 100 is rechargeable. Discharging and charging of the battery 100 may be accomplished by reversible intercalation and de-intercalation, respectively, of lithium ions into and from the host materials of the anode 102 and the cathode 106. The electrolyte formulation includes a lithium salt present at a concentration suitable for enabling lithium ion and electron transport through the electrolyte 104 between the cathode 106 and the anode 102 during the discharge and recharge operations. The voltage of the battery 100 may be based on redox potentials of the anode 102 and the cathode 106, where lithium ions are accommodated or released at a lower potential in the former and a higher potential in the latter. To allow both a higher energy density and a higher voltage platform to deliver that energy, the cathode 106 includes an active cathode material for high voltage operations above 4.3 V, such as super high voltage operations above 4.4 V.

Examples of suitable high voltage cathode materials include phosphates, fluorophosphates, fluorosulfates, fluorosilicates, spinels, lithium-rich layered oxides, and composite layered oxides. Further examples of suitable cathode materials include: spinel structure lithium metal oxides, layered structure lithium metal oxides, lithium-rich layered structured lithium metal oxides, lithium metal silicates, lithium metal phosphates, metal fluorides, metal oxides, sulfur, and metal sulfides. Examples of suitable anode materials include conventional anode materials used in lithium ion batteries, such as lithium, graphite (“LiₓC₆”), and other carbon, silicate, or oxide-based anode materials. In at least one embodiment, the cathode active material is LCO, and the anode active material is a composite graphite. The LCO has the general formula LiₓCo_{y}O_{z}, such as, but not limited to, LiCoO₂. Other examples of high energy cathode active materials may be utilized for the cathode 106 include lithium nickel manganese cobalt oxides (referred to herein as NMC) and lithium nickel cobalt aluminum oxides (referred to herein as NCA). The formula for NMC may be LiNiₓMn_{y}Co_{z}O_{w}, where 0<x<1, 0<y<1, 0<z<1, x+y+z=1, and 0<w≤2. NMC cathode materials include, but are not limited to, electrically active materials containing LiNi_{0.33}Mn_{0.33}Co_{0.33}O₂, LiNi_{0.6}Mn_{0.2}Co_{0.2}O₂, LiNi_{0.8}Mn_{0.1}Co_{0.1}O₂, and LiNi_{0.5}Mn_{0.3}Co_{0.2}O₂. One example formula for NCA is LiNi_{0.8}Co_{0.15}Al_{0.05}O₂.

The electrolyte 104 according to some embodiments of the invention can be formed by starting with a base composition and mixing in additives according the embodiments disclosed herein. The resulting liquid electrolyte can have properties particularly suited for operation at super high voltages and/or high temperatures. The base composition can include one or more solvents and one or more lithium-containing salts. Examples of suitable solvents include non-aqueous solvents such as carbonates, sulfones, silanes, nitriles, esters, ethers, and combinations thereof. The carbonates can include ethylene carbonate (EC), dimethyl carbonate, ethyl methyl carbonate, propylene carbonate, methyl propyl carbonate, vinylene carbonate (VC), and diethyl carbonate (DEC). The base electrolyte composition optionally also includes one or more additional small-molecule additives.

Resulting performance characteristics of a battery can depend upon the identity of one or more particular additives used to form the liquid electrolyte, the identity of the electrode active materials, an amount of the additive used, and, in the case of a combination of multiple additives, a relative amount of each additive within the combination. Accordingly, the resulting performance characteristics can be fine-tuned or optimized by proper selection of the additive(s) relative to the electrode active materials and adjusting amounts of the additive(s) in the electrolyte formulas.

Preparing the electrolyte can be carried out using a variety of techniques, such as by mixing the base electrolyte composition and the additives, dispersing the additives within the base electrolyte composition, dissolving the additives within the base electrolyte composition, or otherwise placing these components in contact with one another. The additives can be provided in a liquid form, a powdered form (or another solid form), or a combination thereof. The additives can be incorporated in the electrolyte prior to, during, or subsequent to battery assembly.

The electrolyte formulations described herein can be used for a variety of batteries containing a high voltage cathode or a low voltage cathode, and in batteries operated at high temperatures, although the electrolytes are particularly useful at high voltages and super high voltages at or above 4.4 V. As described herein, these electrolyte formulations have experimentally demonstrated increased charge capacity retention and energy retention over the lifetime of lithium ion batteries containing LCO cathodes and graphite anodes when cycled and/or operated at high voltages and super high voltages.

The lithium ion batteries disclosed herein can be conditioned by cycling prior to commercial sale or use in commerce. Such conditioning can include, for example, cycling the battery through one, two, three, four, five, or more cycles. Each cycle includes charging the battery and discharging the battery at a rate of 0.05 C (e.g., a current of 8.75 mA/g) between 4.48 V and 3.0 V (or another voltage range) versus a reference counter electrode, such as a graphite anode (e.g., a silicon-containing graphite anode). A voltage relative to a graphite anode may be comparable to a slightly greater relative to a different reference electrode, such as a lithium anode. For example, 4.48 V relative to a silicon-containing graphite anode may be greater than 4.5 V, such as 4.52 V or 4.53 V relative to a lithium anode. Voltages provided herein refer to a graphite anode as the reference electrode unless otherwise specified.

Charging and discharging can be carried out at a higher or lower rate, such as at a rate of 0.1 C (e.g., a current of 17.5 mA/g), 0.2 C (e.g., a current of 35 mA/g), 0.5 C (e.g., a current of 87.5 mA/g), or 1 C (e.g., a current of 175 mA/g). Typically a battery is conditioned with one cycle by charging at 0.05 C rate to 4.48 V followed by applying constant voltage until the current reaches 0.02 C, and then discharging at 0.05 C rate to 3 V. The conditioning can cause the formation of the cathode SEI and the anode SEI. The one or more additives may react, decompose, or undergo other modifications during initial battery cycling. As such, references to amounts and concentrations of additives refer to an initial amounts and concentrations within the electrolyte solution prior to battery cycling.

The amount or concentration of a particular additive can be expressed in terms of a weight percent of the additive relative to a total weight of the electrolyte (or wt. %). For example, an amount of each additive present in the electrolyte can be in the range of about 0.01 wt. % to about 10 wt. %, such as from about 0.05 wt. % to about 8 wt. %, from about 0.1 wt. % to about 4 wt. %, from about 0.15 wt. % to about 1 wt. %, and from about 0.2 wt. % to about 0.7 wt. %. Certain tested concentrations of additives include 0.2 wt. % and 0.5 wt. %.

In certain embodiments, each additive is present at an amount that is significantly lower than the amount of electrolyte salt present in the electrolyte formulation. In certain embodiments, the concentration of each additive in the electronic formulation is less than or equal to the concentration at which the additive would be at the saturation point in the electrolyte solvent. An amount of an additive also can be expressed in terms of a ratio of the number of moles of the additive per unit surface area of either, or both, electrode materials. For example, an amount of an additive can be in the range of about 10⁻⁷ mol/m² to about 10⁻² mol/m², such as from about 10⁻⁷ mol/m² to about 10⁻⁵ mol/m², from about 10⁻⁵ mol/m² to about 10⁻³ mol/m², from about 10⁻⁶ mol/m² to about 10⁻⁴ mol/m², or from about 10⁻⁴ mol/m² to about 10⁻² mol/m².

The phosphorus-containing, cathode SEI formation additive according to a non-limiting example is a phosphoranylidene. In an embodiment, the phosphoranylidene additive can be represented by formula (1):

R₁R₂R₃P═NR₄ (1)

In formula (1), R₁, R₂, and R₃ are each independently an alkyl group, an aromatic group, a heteroaromatic group, a vinyl group, or an alkenyl group. For example, R₁, R₂, and R₃ can be the same functional group or different functional groups. The component R₄ can represent an alkyl group, an aromatic group, a heteroaromatic group, a vinyl group, an alkenyl group, a carbonyl group, —N⁺═C⁻, Ph₃P⁺, —P═OPh₂, —Si(R₁R₂R₃), or —SO₂—R₁. A non-limiting example phosphoranylidene additive according to formula (1) is 1,1,1-Trimethyl-N-triphenylphosphoranylidene)silanamine (referred to herein as TTPS). The TTPS additive is represented by formula (2):

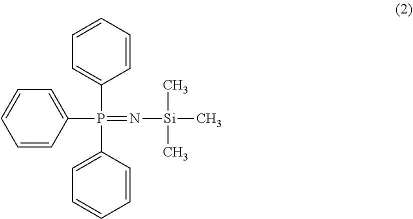 [SMILES: C[Si](C)(C)N=P(c1ccccc1)(c1ccccc1)c1ccccc1]

In another embodiment, the phosphoranylidene additive can be represented by formula (3):

R₁R₂R₃P═C═C═X (3)

In formula (3), R₁, R₂, and R₃ are each independently an alkyl group, an aromatic group, a heteroaromatic group, a vinyl group, or an alkenyl group. The component X can be an oxygen atom (O), a sulfur atom (S), NR₁, CHR₁, CHOR₁, CR₁R₂, CHF, CHCl, or CHBr. A non-limiting example phosphoranylidene additive according to formula (3) is (triphenylphosphoranylidene)ketene (referred to herein as TPK). The TPK additive is represented by formula (4):

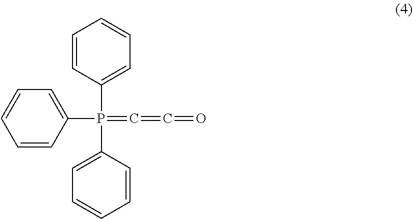 [SMILES: O=C=C=P(c1ccccc1)(c1ccccc1)c1ccccc1]

When present in the electrolyte of a lithium ion battery that includes high energy electrodes, such as an LCO cathode and graphite anode, the phosphoranylidene additive can improve the protection on the cathode surface. For example, without being bound by a particular theory or mechanism of action, the incorporated phenyl group could be oxidized to form more polymeric CEI layer which is less soluble in the electrolyte. The incorporated heteroatoms such as P and N could further ameliorate the CEI properties. In addition, the highly reactive functional group such as ketene and trimethylsilyl group could function as moisture and hydrogen fluoride (HF) scavengers, which could minimize the HF corrosion on the cathode surface to prevent the transition metal dissolution.

The phosphorus-containing, cathode SEI formation additive according to another non-limiting example is a phosphonite. The phosphonite additive can be represented by formula (5):

(R₁O)(R₂O)(R₃O)P (5)

In formula (5), R₁, R₂, and R₃ are each independently an alkyl group, an aromatic group, an alkoxy group, a vinyl group, or an alkenyl group. A non-limiting example phosphonite additive according to formula (5) is dimethyl phenylphosphonite (referred to herein as DMPP). The DMPP additive is represented by formula (6):

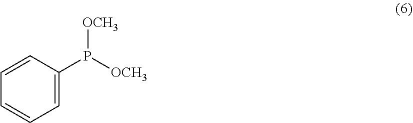 [SMILES: COP(OC)c1ccccc1]

When present in the electrolyte of the high energy lithium ion battery including LCO/Gr cell chemistry, for example, the phosphonite additive contributes to the formation of the cathode SEI layer on the cathode surface. For example, without being bound by a particular theory or mechanism of action, the phosphonite additive can serve as an HF scavenger because the phosphonite group could coordinate with fluorine anions. Hence, electrolyte decomposition, HF attack, and cobalt dissolution could be substantially reduced or even eliminated. When the phosphonite additive, such as DMPP, is combined with an anode SEI formation additive, such as LiFSI, a synergistic effect is observed which further improves the cycling performance of the LCO/Gr cell chemistry when cycled at least to 4.4 V.

The phosphorus-containing, cathode SEI formation additive according to another non-limiting example is a fluorocyclophosphazene. The fluorocyclophosphazene additive can be represented by formula (7):

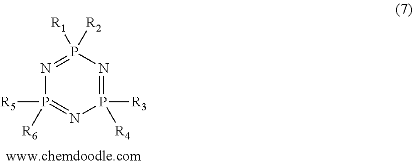

In formula (7), R₁, R₂, R₃, R₄, R₅, and R₆ are each independently an alkyl group, an aromatic group, an alkoxy group, a vinyl group, an alkenyl group, a halogen atom, a fluorine atom, or an oxygen atom. At least one of R₁-R₆ is a fluorine atom. A first non-limiting example fluorocyclophosphazene additive according to formula (7) is ethoxy(pentafluoro) cyclotriphosphazene (referred to herein as PFPN). The PFPN additive is represented by formula (8):

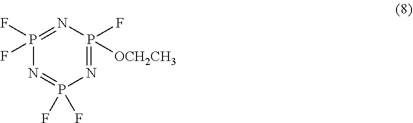 [SMILES: CCOP1(F)=NP(F)(F)=NP(F)(F)=N1]

A second non-limiting example fluorocyclophosphazene additive according to formula (7) is hexafluorocyclotriphosphazene (referred to herein as HFPN). The HFPN additive is represented by formula (9):

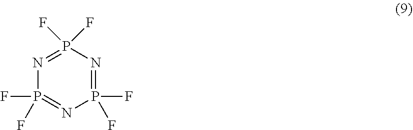 [SMILES: FP1(F)=NP(F)(F)=NP(F)(F)=N1]

A third non-limiting example fluorocyclophosphazene additive according to formula (7) is hexakis(1H,1H-trifluoroethoxy)phosphazene (HFEPN). The HFEPN additive is represented by formula (10):

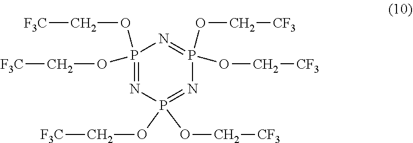 [SMILES: FC(F)(F)COP1(OCC(F)(F)F)=NP(OCC(F)(F)F)(OCC(F)(F)F)=NP(OCC(F)(F)F)(OCC(F)(F)F)=N1]

The fluorocyclophosphazene additive according to formula (7) can also contribute to the formation of the cathode SEI layer on a high voltage lithium ion battery, such as the LCO/Gr cell chemistry. For example, without being bound by a particular theory or mechanism of action, the incorporated P and F elements in the fluorocyclophosphazene additive can tune the cathode SEI properties to meet high voltage cycling requirements. Furthermore, the fluorocyclophosphazene additive was observed to provide a synergistic effect with anode SEI formation additives, such as FEC, LiDFOB and LiFSI, which improves the cycling performance.

For experimental testing, battery cells were produced that were substantially uniform except for which high voltage phosphorus-containing additive is present in the electrolyte and the concentration of the high voltage additive. The high voltage additives that were tested were different phosphoranylidenes, phosphonites, and fluorophosphazenes. The additives were tested at various concentrations, including 0.2 wt. %, 0.5 wt. %, and 2.0 wt. % relative to the total weight of the electrolyte. Each of the battery cells was formed in a high purity Argon filled glove box (M-Braun, O₂ and humidity content <0.1 ppm). For the cathode, a commercial LCO material was mixed with dry poly(vinylidene fluoride), carbon black powder, and liquid 1-methyl-2-pyrrolidinone to form a cathode slurry. The cathode slurry was deposited on an aluminum current collector and dried to form a composite cathode film. For the anode, a graphitic carbon was mixed with dry poly(vinylidene fluoride), carbon black powder, and liquid 1-methyl-2-pyrrolidinone to form an anode slurry. The anode slurry was deposited on a copper current collector and dried to form a composite anode film. Each battery cell included the composite cathode film, a polypropylene separator, and the composite anode film.

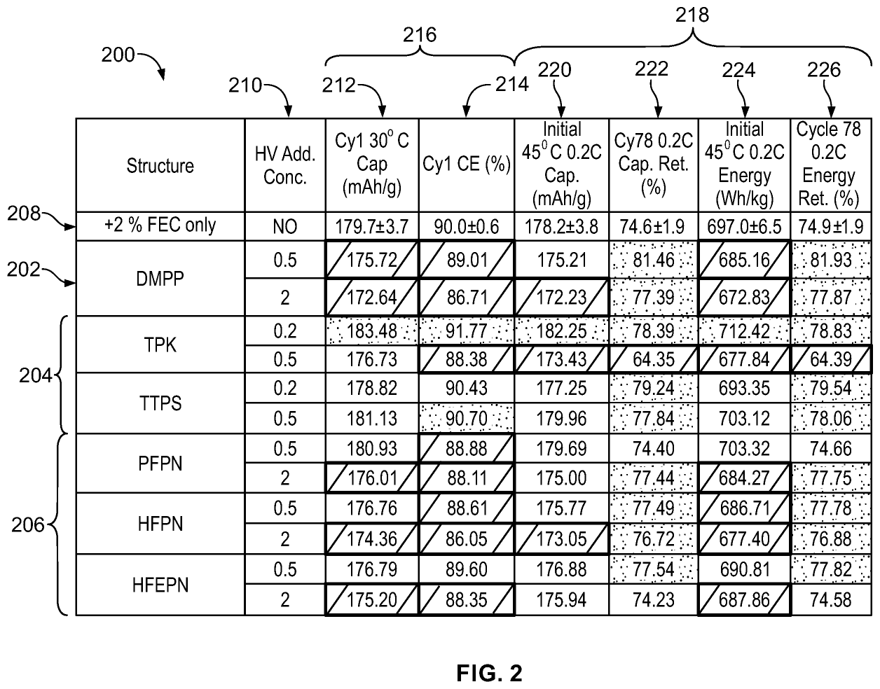

A liquid electrolyte was formed with a base formulation including lithium hexafluorophosphate (referred to herein as LiPF6) as the lithium salt and a solution of ethylene carbonate (EC), diethyl carbonate (DEC), and vinylene carbonate (VC) as the solvent. The LiPF6 may be present in the electrolyte at a concentration of about 1M. Fluoroethylene carbonate (FEC) was added to the base formulation to function as an anode SEI formation additive. The FEC was present at a concentration of 2 wt % relative to the total weight of the electrolyte. The specific high voltage phosphorus-containing additive to be tested was added to the base formulation at one of three concentrations (e.g., 0.2 wt. %, 0.5 wt. %, or 2.0 wt. %). Each battery cell was then sealed and initially cycled at ambient temperature using 0.1 C charge to upper cutoff voltage 4.48 V followed by constant voltage hold until the current dropped to 0.01 C, and then the battery cell was discharged to 3.0 V using 0.1 C constant current. The cycle was repeated one more time prior to high temperature cycling. The high temperature cycling was performed at 45° C. using 0.5 C charge and discharge between 4.48-3 V (with respect to a silicon-containing graphite anode). The results of the cycle life testing are provided in table 200 shown in FIG. 2.

FIG. 2 is a table 200 that summarizes data for the cycle life testing of lithium ion battery cells according to some embodiments. The table 200 lists various high voltage additives that were experimentally tested, including DMPP (e.g., formula (6)) from the phosphonite class 202; TPK (e.g., formula (4)) and TTPS (e.g., formula (2)) from the phosphoranylidene class 204; and PFPN (e.g., formula (8)), HFPN (e.g., formula (9)), and HFEPN (e.g., formula (10)) from the fluorocyclophosphazene class 206. The TPK and TTPS additives in the phosphoranylidene class 204 were tested at concentrations of both 0.2 wt. % and 0.5 wt. % relative to the total weight of the electrolyte. The DMPP additive from the phosphonite class 202 and the PFPN, HFPN, and HFEPN additives from the fluorocyclophosphazene class 206 were tested at concentrations of both 0.5 wt. % and 2.0 wt. % relative to the total weight of the electrolyte. For comparison purposes, a control battery was tested in which the electrolyte lacks any high voltage phosphorus-containing additive. The electrolyte of the control includes the 2 wt. % FEC additive only, whereas the electrolyte of the tested batteries includes the 2 wt. % FEC in combination with a specific one of the high voltage additives. The control data is shown in row 208.

The columns in the table 200 represent the additive concentration 210; the discharge capacity 212 at 30° C. (in mAh/g) and coulombic efficiency (CE) 214 (in %) during the formation cycle 216; and data during long-term cycling 218. The long-term cycling data 218 includes initial discharge capacity 220 at 45° C. and 0.2 C (in mAh/g), capacity retention 222 (in %) at cycle 78, initial energy density 224 (in Wh/kg), and energy retention 226 (in %) at cycle 78. As stated above, the long-term cycling was performed at 45° C. using 0.5 C charge to an upper cutoff voltage of 4.48 V. The initial conditions at 220 and 224 may refer to the first cycle of the long-term cycling after the formation cycle is complete. The control data in row 208 includes the average of measured values plus/minus the first standard deviation values. The tested battery cells are evaluated based on the comparison to the control data. The cells in the table 200 that represent improved performance over the control data, beyond the first standard deviation values, are identified by a dotted speckle pattern. The cells that represent worse performance than the control data, outside of the first standard deviation values, are identified by a bold outline and diagonal line markings. The cells that represent similar performance to the control data, within the plus/minus range of the first standard deviation values relative to the control data values, are identified as the cells that are plain and lack special markings.

In general, a significant majority (e.g., 9 out of 12 or 75%) of the tested battery cells demonstrated improved capacity retention and energy retention at the 78^{th} cycle of the high voltage cycling relative to the control battery. The battery cells are only considered an improvement if the measured data is better than the average measured value of the control and outside of the first standard deviation. Only one of the twelve tested battery cells (e.g., TPK at 0.5 wt. %) demonstrated noticeably worse long-term capacity retention or energy retention than the control. For example, the TPK at 0.5 wt. % data was worse than the average measured value of the control and outside of the first standard deviation.

The phosphonite 202 DMPP demonstrated an improvement over the control in both capacity retention and energy retention at the 78^{th} cycle, for both additive concentration levels. The 0.5 wt. % concentration DMPP the demonstrated the best long-term capacity retention and energy retention among the tested batteries at greater than 81% for each.

The phosphoranylidene 204 TPK at 0.2 wt. % demonstrated the best overall performance, showing improvement over the control in all categories, even during the formation cycle and the initial high temperature cycle. As mentioned, the 0.5 wt. % TPK performed worse than the control. This performance discrepancy indicates that a preferred concentration for the TPK additive is less than 0.5 wt. %, such as no greater than 0.35 wt. %, no greater than 0.3 wt. %, or no greater than 0.25 wt. %. Without being bound by a particular theory or mechanism of action, the higher concentration of TPK may negatively affect cell performance by increasing the thickness of the cathode SEI layer, which undesirably increases the electrical resistance.

The phosphoranylidene 204 TTPS demonstrated an improvement over the control in both capacity retention and energy retention at the 78^{th} cycle, for both tested concentration levels, and performed similar to the control during the initial cycles. These results indicate that the performance of TTPS is not as dependent on the concentration as TPK, as both the 0.2 wt. % and the 0.5 wt. % provided good performance.

The fluorocyclophosphazenes 206 performed relatively similar to each other and generally demonstrated improved performance over the control in both capacity retention and energy retention at the 78^{th} cycle. The 2 wt. % concentration of PFPN performed noticeably better than the 0.5 wt. % PFPN, which is the opposite phenomenon experienced by TPK. Without being bound by a particular theory or mechanism of action, the higher concentration of PFPN may improve capacity and energy retention over the cycle life, relative to the lower concentration, by forming a more robust cathode SEI. The more robust cathode SEI may provide better protection of the cathode active material and avoid side reactions and decomposition better than the cathode SEI formed by the lower concentration of PFPN. Conversely, the 0.5 wt. % HFEPN performed better than the 2 wt. % HFEPN, potentially due to lower electrical resistance across the cathode SEI layer than the higher concentration additive.

The table 200 clearly demonstrates the general concept that including a phosphonite, phosphoranylidene, or fluorocyclophosphazene additive in the electrolyte improves the capacity retention and energy retention over the cycle life of the battery cell, even when operated at high voltages greater than 4.3 V. For example, the data in table 200 was collected from experiments performed at 4.48 V and also at the relatively high temperature 45° C. Some additives that performed particularly well in these high voltage and high temperature conditions include the phosphoranylidenes TPK and TTPS and the phosphonite DMPP.

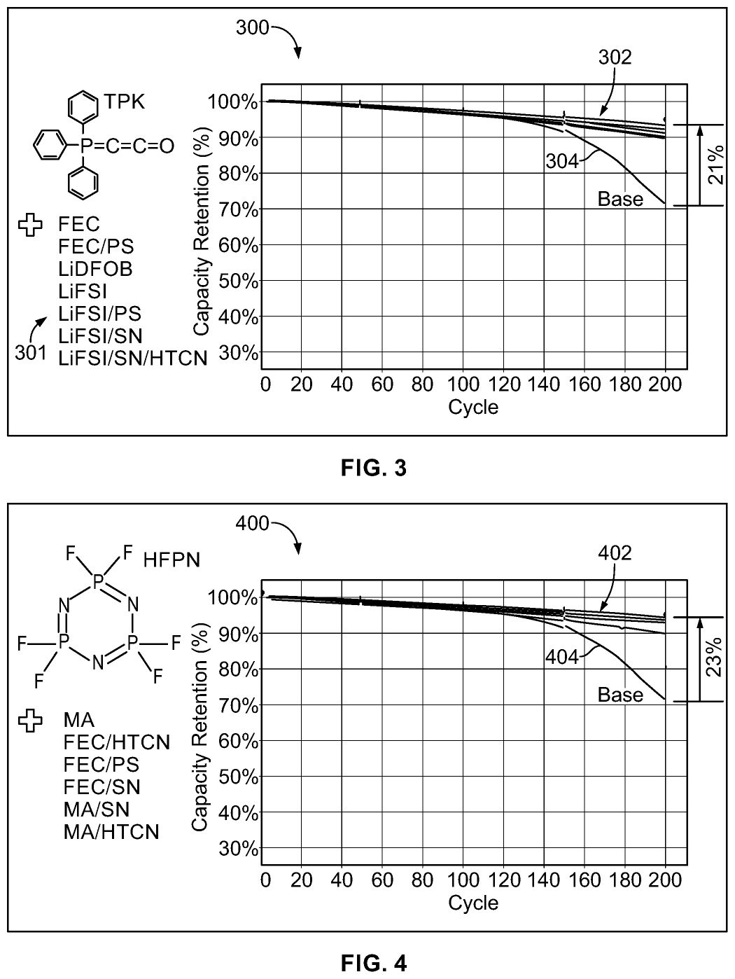

FIG. 3 is a graph 300 showing the capacity retention of the phosphoranylidene additive TPK over 200 cycles when paired with different anode SEI formation additives. Each data line in the graph 300 represents a battery cell that includes the TPK additive, and the only difference between the various battery cells is the identity of the one or more additives paired with the TPK. The pairing additives are generally additives that reduce gas generation and additives that contribute to the formation of the anode SEI layer. The tested pairing additives are shown in the list 301 and include FEC, FEC/PS (e.g., FEC mixed with PS), LiDFOB, LiFSI, LiFSI/PS, LiFSI/SN, and LiFSI/SN/HTCN. The battery cells were tested from 3 to 4.48 V. The graph 300 shows that the capacity retention of the various tested batteries is relatively similar over the 200 cycles, as the lines are clustered in a group 302. The deviation between the battery having the highest and lowest capacity retention is only about 5% at the 200^{th} cycle, and approximately all tested batteries had capacity retention of 90% or greater that the 200^{th} cycle.

Graph 300 also plots a control line 304 that represents a battery including a base electrolyte that lacks both TPK and the anode additives in the list 301. For example, the base electrolyte includes LiPF6 as the lithium salt with a solvent formed by a mixture of EC, DEC, and VC. The capacity retention of the control battery is at least similar to the tested batteries through the first 100 cycles but gradually deviates from the group 302. At the 200^{th} cycle, the capacity retention of the control battery is 21% worse than the average in the group 302 of tested batteries. The graph 300 indicates that the TPK additive can be combined with various anode SEI formation additives, including any of the additives in the list 301, to provide approximately consistent and beneficial capacity retention over the cycle life.

FIG. 4 is a graph 400 showing the capacity retention of the fluorocyclophosphazene additive HFPN over 200 cycles when paired with different gas reduction and anode SEI formation additives. Graph 400 is similar to the graph 300 in FIG. 3 except for the additives used in the tested batteries. For example, each tested battery includes the HFPN additive with either maleic anhydride (MA), MA/SN, MA/HTCN, FEC/HTCN, FEC/PS, or FEC/SN. The capacity retention of the tested batteries is relatively similar over the 200 cycles, as the lines are clustered in a group 402. The deviation between the battery having the highest and lowest capacity retention is only about 5% at the 200^{th} cycle, and approximately all tested batteries had capacity retention of 90% or greater that the 200^{th} cycle. All of the tested batteries performed significantly better than a control battery shown at line 404, which demonstrated a 23% less capacity retention at the 200^{th} cycle than the average of the tested batteries. The graph 400 indicates that HFPN is compatible with the various anode SEI formation additives tested and demonstrates beneficial performance over the cycle life.

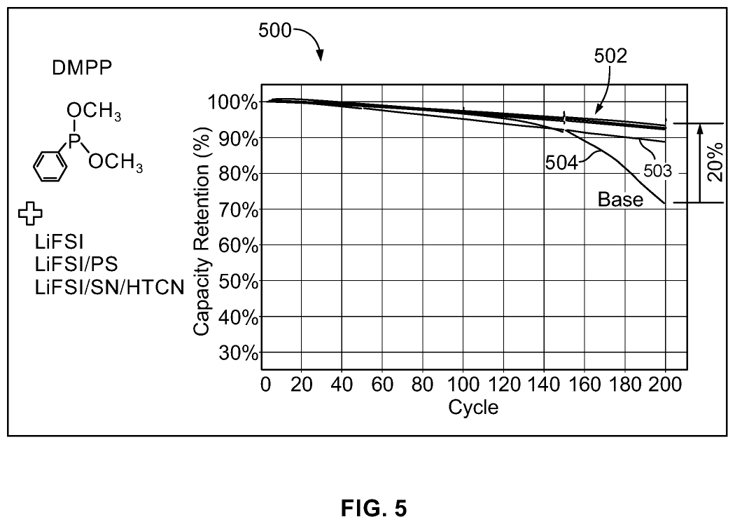

FIG. 5 is a graph 500 showing the capacity retention of the phosphonite additive DMPP over 200 cycles when paired with different gas reduction and anode SEI formation additives. Graph 500 is similar to graphs 300 and 400 except that the tested batteries each include the DMPP additive with either LiFSI, LiFSI/PS, or LiFSI/SN/HTCN. The capacity retention of the tested batteries with LiFSI and LiFSI/PS are relatively similar over the 200 cycles, as the two lines are clustered in a group 502. The battery that includes LiFSI/SN/HTCN, indicated by line 503, has lower capacity retention than the group 502, but the deviation is only about 5% at the 200^{th} cycle. Plus, the battery with the LiFSI/SN/HTCN additive has a capacity retention of about 90% at the 200^{th} cycle, which is about 15% better than the control battery indicated by line 504. The LiFSI and LiFSI/PS batteries demonstrated about 20% higher capacity retention than the control battery at the 200^{th} cycle. The graph 500 indicates that DMPP is compatible with the various anode SEI formation additives tested and demonstrates beneficial performance over the cycle life.

In one or more embodiments, a lithium ion battery is provided that includes a cathode, an anode, and an electrolyte. The electrolyte includes a lithium salt, a solvent, a first additive, and a second additive. The first additive contributes to formation of a cathode solid electrolyte interface (SEI) on a surface of the cathode. The second additive contributes to formation of an anode SEI on a surface of the anode. The first additive is one or more of a phosphonite compound, a phosphoranylidene compound, or a fluorocyclophosphazene compound.

Optionally, Optionally, the first additive is a phosphoranylidene compound and is represented by formula (i):

R₁R₂R₃P═NR₄ (i)

R₁, R₂, and R₃ are each independently an alkyl group, an aromatic group, a heteroaromatic group, a vinyl group, or an alkenyl group. R₄ is an alkyl group, an aromatic group, a heteroaromatic group, a vinyl group, an alkenyl group, a carbonyl group, —N⁺═C⁻, Ph₃P⁺, —P═OPh₂, —Si(R₁R₂R₃), or —SO₂—R₁. Optionally, the first additive is 1,1,1-trimethyl-N-triphenylphosphoranylidene) silanamine (TTPS).

Optionally, the first additive is a phosphoranylidene compound and is represented by formula (ii):

R₁R₂R₃P═C═C═X (ii)

R₁, R₂, and R₃ are each independently an alkyl group, an aromatic group, a heteroaromatic group, a vinyl group, or an alkenyl group. X is one of O, S, NR₁, CHR₁, CHOR₁, CR₁R₂, CHF, CHCl, or CHBr. Optionally, the first additive is (triphenylphosphoranylidene)ketene (TPK).

Optionally, the first additive is a phosphonite compound and is represented by formula (iii):

(R₁O)(R₂O)(R₃O)P (iii)

R₁, R₂, and R₃ are each independently an alkyl group, an aromatic group, an alkoxy group, a vinyl group, or an alkenyl group. Optionally, the first additive is dimethyl phenylphosphonite (DMPP).

Optionally, the first additive is a fluorocyclophosphazene compound and is represented by formula (iv):

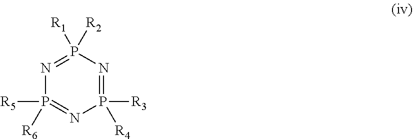

R₁, R₂, R₃, R₄, R₅, and R₆ are each independently an alkyl group, an aromatic group, an alkoxy group, a vinyl group, an alkenyl group, a halogen atom, a fluorine atom, or an oxygen. At least one of R₁ through R₆ is a fluorine atom. Optionally, the first additive is ethoxy(pentafluoro) cyclotriphosphazene (PFPN). Optionally, the first additive is hexafluorocyclotriphosphazene (HFPN). Optionally, the first additive is hexakis(1H,1H-trifluoroethoxy)phosphazene (HFEPN).

Optionally, the second additive includes one of fluoroethylene carbonate (FEC), lithium bis(trifluoromethanesulfonyl)imide (LiF SI), or lithium difluoro(oxalato)borate (LiDFOB). The cathode may include a lithium cobalt oxide active material. The first additive may have a concentration no greater than 2 wt. % relative to a total weight of the electrolyte. The lithium ion battery may have a capacity retention of at least 76% at cycle 78 when charged and discharged at least 78 times to a voltage of at least 4.4 V.

In one or more embodiments, a lithium ion battery is provided that includes a cathode, an anode, and an electrolyte. The electrolyte includes a lithium salt, a solvent, and a phosphoranylidene additive that contributes to formation of a cathode solid electrolyte interface (SEI) on a surface of the cathode. The phosphoranylidene additive is represented by formula (i) or formula (ii):

R₁R₂R₃P═NR₄ (i)

R₁R₂R₃P═C═C═X (ii)

In formulas (i) and (ii), R₁, R₂, and R₃ are each independently an alkyl group, an aromatic group, a heteroaromatic group, a vinyl group, or an alkenyl group. In formulas (i) and (ii), R₄ is an alkyl group, an aromatic group, a heteroaromatic group, a vinyl group, an alkenyl group, a carbonyl group, —N⁺═C⁻, Ph₃P⁺, —P═OPh₂, —Si(R₁R₂R₃), or —SO₂—R₁. In formula (ii), X is one of O, S, NR₁, CHR₁, CHOR₁, CR₁R₂, CHF, CHCl, or CHBr.

Optionally, the phosphoranylidene additive is represented by formula (i) and is 1,1,1-trimethyl-N-triphenylphosphoranylidene)silanamine (TTPS).

Optionally, the phosphoranylidene additive is represented by formula (ii) and is (triphenylphosphoranylidene)ketene (TPK). The TPK additive may have a concentration no greater than 0.35 wt. % relative to a total weight of the electrolyte.

Optionally, the phosphoranylidene additive is a first additive, and the electrolyte further includes a second additive that contributes to formation of an anode SEI on a surface of the anode. The second additive includes one of fluoroethylene carbonate (FEC), lithium bis(trifluoromethanesulfonyl)imide (LiF SI), or lithium difluoro(oxalato)borate (LiDFOB).

As used herein, value modifiers such as “about,” “substantially,” and “approximately” inserted before a numerical value indicate that the value can represent other values within a designated threshold range above and/or below the specified value, such as values within 5%, 10%, or 15% of the specified value.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A lithium ion battery comprising:
a cathode;
an anode; and
an electrolyte that includes a lithium salt, a solvent, a first additive that contributes to formation of a cathode solid electrolyte interface (SEI) on a surface of the cathode, and a second additive that contributes to formation of an anode SEI on a surface of the anode,
wherein the first additive is one or more of a phosphonite compound, a phosphoranylidene compound, or a fluorocyclophosphazene compound.

2. The lithium ion battery of claim 1, wherein the first additive is a phosphoranylidene compound and is represented by formula (i):
R₁R₂R₃P═NR₄ (i)
wherein R₁, R₂, and R₃ are each independently an alkyl group, an aromatic group, a heteroaromatic group, a vinyl group, or an alkenyl group; and R₄ is an alkyl group, an aromatic group, a heteroaromatic group, a vinyl group, an alkenyl group, a carbonyl group, —N⁺═C⁻, Ph₃P⁺, —P═OPh₂, —Si(R₁R₂R₃), or —SO₂—R₁.

3. The lithium ion battery of claim 2, wherein the first additive is 1,1,1-trimethyl-N-triphenylphosphoranylidene)silanamine (TTPS).

4. The lithium ion battery of claim 1, wherein the first additive is a phosphoranylidene compound and is represented by formula (ii):
R₁R₂R₃P═C═C═X (ii)
wherein R₁, R₂, and R₃ are each independently an alkyl group, an aromatic group, a heteroaromatic group, a vinyl group, or an alkenyl group; and X is one of O, S, NR₁, CHR₁, CHOR₁, CR₁R₂, CHF, CHCl, or CHBr.

5. The lithium ion battery of claim 4, wherein the first additive is (triphenylphosphoranylidene)ketene (TPK).

6. The lithium ion battery of claim 1, wherein the first additive is a phosphonite compound and is represented by formula (iii):
(R₁O)(R₂O)(R₃O)P (iii)
wherein R₁, R₂, and R₃ are each independently an alkyl group, an aromatic group, an alkoxy group, a vinyl group, or an alkenyl group.

7. The lithium ion battery of claim 6, wherein the first additive is dimethyl phenylphosphonite (DMPP).

8. The lithium ion battery of claim 1, wherein the first additive is a fluorocyclophosphazene compound and is represented by formula (iv): 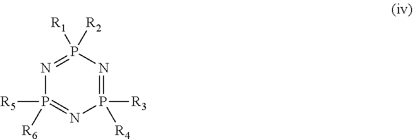
wherein R₁, R₂, R₃, R₄, R₅, and R₆ are each independently an alkyl group, an aromatic group, an alkoxy group, a vinyl group, an alkenyl group, a halogen atom, a fluorine atom, or an oxygen;
and at least one of R₁-R₆ is fluorine.

9. The lithium ion battery of claim 8, wherein the first additive is ethoxy(pentafluoro)cyclotriphosphazene (PFPN).

10. The lithium ion battery of claim 8, wherein the first additive is hexafluorocyclotriphosphazene (HFPN).

11. The lithium ion battery of claim 8, wherein the first additive is hexakis(1H,1H-trifluoroethoxy)phosphazene (HFEPN).

12. The lithium ion battery of claim 1, wherein the second additive includes one of fluoroethylene carbonate (FEC), lithium bis(trifluoromethanesulfonyl)imide (LiFSI), or lithium difluoro(oxalato)borate (LiDFOB).

13. The lithium ion battery of claim 1, wherein the cathode includes a lithium cobalt oxide active material.

14. The lithium ion battery of claim 1, wherein the first additive has a concentration no greater than 2 wt. % relative to a total weight of the electrolyte.

15. The lithium ion battery of claim 1, wherein the lithium ion battery has a capacity retention of at least 76% at cycle 78 when charged and discharged at least 78 times to a voltage of at least 4.4 V.

16. A lithium ion battery comprising:
a cathode;
an anode; and
an electrolyte that includes a lithium salt, a solvent, and a phosphoranylidene additive that contributes to formation of a cathode solid electrolyte interface (SEI) on a surface of the cathode, wherein the phosphoranylidene additive is represented by formula (i) or formula (ii):
R₁R₂R₃P═NR₄ (i)
R₁R₂R₃P═C═C═X (ii)
wherein R₁, R₂, and R₃ are each independently an alkyl group, an aromatic group, a heteroaromatic group, a vinyl group, or an alkenyl group; R₄ is an alkyl group, an aromatic group, a heteroaromatic group, a vinyl group, an alkenyl group, a carbonyl group, —N⁺═C⁻, Ph₃P⁺, —P═OPh₂, —Si(R₁R₂R₃), or —SO₂—R₁; and X is one of O, S, NR₁, CHR₁, CHOR₁, CR₁R₂, CHF, CHCl, or CHBr.

17. The lithium ion battery of claim 16, wherein the phosphoranylidene additive is represented by formula (i) and is 1,1,1-trimethyl-N-triphenylphosphoranylidene)silanamine (TTPS).

18. The lithium ion battery of claim 16, wherein the phosphoranylidene additive is represented by formula (ii) and is (triphenylphosphoranylidene)ketene (TPK).

19. The lithium ion battery of claim 18, wherein the TPK additive has a concentration no greater than 0.35 wt. % relative to a total weight of the electrolyte.

20. The lithium ion battery of claim 16, wherein the phosphoranylidene additive is a first additive, and the electrolyte further includes a second additive that contributes to formation of an anode SEI on a surface of the anode, the second additive including one of fluoroethylene carbonate (FEC), lithium bis(trifluoromethanesulfonyl)imide (LiFSI), or lithium difluoro(oxalato)borate (LiDFOB).
